(19) United States
(12) Patent Application Publication
(10) Pub. No.: US 2025/0121886 A1
(43) Pub. Date: Apr. 17, 2025

(54) VEHICLE FRONT STRUCTURE

(71) Applicants: Hyundai Motor Company, Seoul (KR); Kia Corporation, Seoul (KR)

(72) Inventors: Jeon Woong Kang, Hwaseong-si (KR); Byeong Cheon Lee, Seoul (KR); Huen Sick Min, Hwaseong-si (KR); Kun Ho Park, Yongin-si (KR)

(21) Appl. No.: 18/608,052

(22) Filed: Mar. 18, 2024

(30) Foreign Application Priority Data
Oct. 12, 2023 (KR) 10-2023-0136096

(51) Int. Cl. B62D 21/15; B62D 21/03

(52) U.S. Cl. CPC B62D 21/155; B62D 21/03

(57) ABSTRACT

An embodiment of a vehicle front structure includes a pair of front side members, a first transverse member connecting front portions of the pair of front side members in a width direction of a vehicle, a second transverse member connecting rear portions of the pair of front side members in the width direction of the vehicle, and a plurality of front modules mounted on the first transverse member and the second transverse member.

### CROSS-REFERENCE TO RELATED APPLICATIONS

This application claims the benefit of Korean Patent Application No. 10-2023-0136096, filed on Oct. 12, 2023, which application is hereby incorporated herein by reference.

### TECHNICAL FIELD

The present disclosure relates to a vehicle front structure.

### BACKGROUND

Vehicles are tested to evaluate crashworthiness through various tests such as frontal impact tests, side impact tests, rear impact tests, and roll-over tests. Recently, small overlap crash tests (simulations of small overlap frontal crashes against a rigid barrier) have been introduced by the Insurance Institute for Highway Safety (IIHS). Such small overlap crash tests are conducted by allowing a small portion (25% of the vehicle width in front of the driver seat) of the vehicle running at 40 MPH (64 KPH) to strike the barrier, known as the most severe one of the known crash tests.

As the weight of a high-voltage battery, the weight and size of a power electronics (PE) module, and the like, in an electric vehicle increase, impact energy may increase, and accordingly the weight of a reinforcing structure for a vehicle body may increase, which may increase the cost, packaging, and the like of the vehicle.

In the event of a small overlap crash, a reaction force generated by the vehicle may be very large, and the degree of damage to the vehicle and the degree of injury to passengers may be very high. However, the electric vehicle according to the related art is designed to protect a passenger compartment and a high-voltage battery, so it may be difficult to effectively cause a lateral displacement of the vehicle in the event of a small overlap crash. In particular, as the weight of the high-voltage battery, the weight and size of the PE module, and the like in the electric vehicle increase, it may be difficult to cause the lateral displacement of the vehicle in the event of a small overlap crash.

The above information described in this background section may include information that is not considered as the prior art that is already publicly known.

### SUMMARY

The present disclosure relates to a vehicle front structure, and more particularly, to a vehicle front structure designed to cause a lateral displacement of the vehicle in the event of an overlap crash, thereby improving crashworthiness.

Embodiments of the present disclosure may solve the above-mentioned problems occurring in the prior art while advantages achieved by the prior art may be maintained intact.

An embodiment of the present disclosure provides a vehicle front structure designed to use a plurality of transverse members provided on the front of a vehicle body and a plurality of front modules mounted on the plurality of transverse members as load paths, thereby effectively causing a lateral displacement of the vehicle in the event of a small overlap crash.

According to an embodiment of the present disclosure, a vehicle front structure may include a pair of front side members, a first transverse member connecting front portions of the pair of front side members in a width direction of a vehicle, a second transverse member connecting rear portions of the pair of front side members in the width direction of the vehicle, and a plurality of front modules mounted on the first transverse member and the second transverse member.

Both end portions of the first transverse member may be mounted on the front portions of the pair of front side members through a pair of first mounting brackets, respectively.

Both end portions of the second transverse member may be mounted on the rear portions of the pair of front side members through a pair of second mounting brackets, respectively.

The vehicle front structure may further include a longitudinal member connecting the first transverse member and the second transverse member in a longitudinal direction of the vehicle.

A front end portion of the longitudinal member may include a first upper extension portion fixed to a top surface of the first transverse member, and a first lower extension portion fixed to a bottom surface of the first transverse member.

A rear end portion of the longitudinal member may include a second upper extension portion fixed to a top surface of the second transverse member, and a second lower extension portion fixed to a bottom surface of the second transverse member.

The vehicle front structure may further include a middle transverse member connecting any one of the pair of front side members and the longitudinal member in the width direction of the vehicle.

The middle transverse member may include a first end portion connected to any one of the pair of front side members, and a second end portion connected to the longitudinal member.

The first end portion of the middle transverse member may be mounted on any one of the pair of front side members through a mounting bracket.

The second end portion of the middle transverse member may include an upper extension portion fixed to a top surface of the longitudinal member, and a lower extension portion fixed to a bottom surface of the longitudinal member.

The vehicle front structure may further include an additional longitudinal member connecting the middle transverse member and the second transverse member in the longitudinal direction of the vehicle.

A front end portion of the additional longitudinal member may include a first upper extension portion fixed to a top surface of the middle transverse member, and a first lower extension portion fixed to a bottom surface of the middle transverse member.

A rear end portion of the additional longitudinal member may include a second upper extension portion fixed to a top surface of the second transverse member, and a second lower extension portion fixed to a bottom surface of the second transverse member.

The vehicle front structure may further include a front subframe located below the pair of front side members. The front subframe may include a front mount mounted on the front portion of each front side member, and a rear mount mounted on the rear portion of each front side member.

The first transverse member may be vertically aligned with the front mount, and the second transverse member may be vertically aligned with the rear mount.

### BRIEF DESCRIPTION OF THE DRAWINGS

The above and other features and advantages of the present disclosure can be more apparent from the following detailed description taken in conjunction with the accompanying drawings, in which:

FIG. 1 illustrates a plan view of a vehicle front structure according to an example embodiment of the present disclosure;

FIG. 2 illustrates a plan view of a vehicle front structure according to an example embodiment of the present disclosure, from which front modules are removed;

FIG. 3 illustrates a side view, viewed in a direction indicated by arrow A of FIG. 2, according to an example embodiment of the present disclosure;

FIG. 4 illustrates a cross-sectional view, taken along line B-B of FIG. 2;

FIG. 5 illustrates a cross-sectional view, taken along line C-C of FIG. 2;

FIG. 6 illustrates a cross-sectional view, taken along line D-D of FIG. 2; and

FIG. 7 illustrates a cross-sectional view, taken along line E-E of FIG. 2.

### DETAILED DESCRIPTION OF ILLUSTRATIVE EMBODIMENTS

Hereinafter, example embodiments of the present disclosure will be described in detail with reference to the accompanying drawings. In the drawings, same reference numerals can be used throughout to designate same or equivalent elements. In addition, a detailed description of well-known techniques associated with the present disclosure can be omitted to not unnecessarily obscure the gist of the present disclosure.

Terms such as “first,” “second,” “A,” “B,” “(a),” and “(b)” may be used to describe the elements in example embodiments of the present disclosure. These terms can be merely used to distinguish one element from another element, and the intrinsic features, sequence, or order, and the like, of the corresponding elements are not necessarily limited by such terms. Unless otherwise defined, all terms used herein, including technical or scientific terms, can have the same meanings as those generally understood by those with ordinary knowledge in the field of art to which the present disclosure pertains. Such terms as those defined in a generally used dictionary can be interpreted as having meanings equal to the contextual meanings in the relevant field of art.

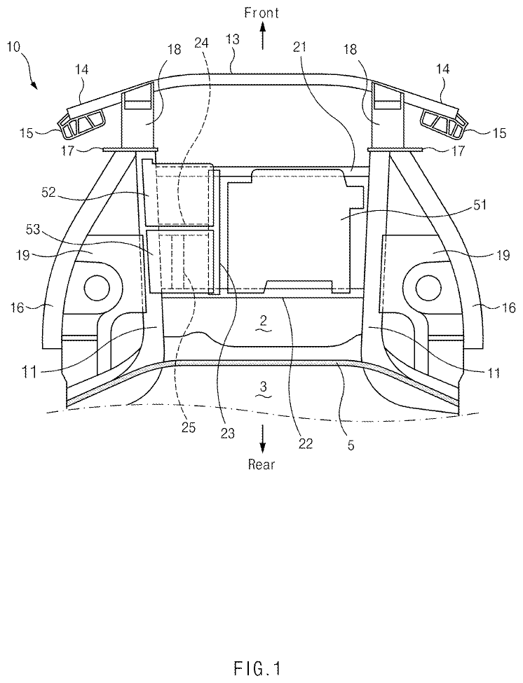

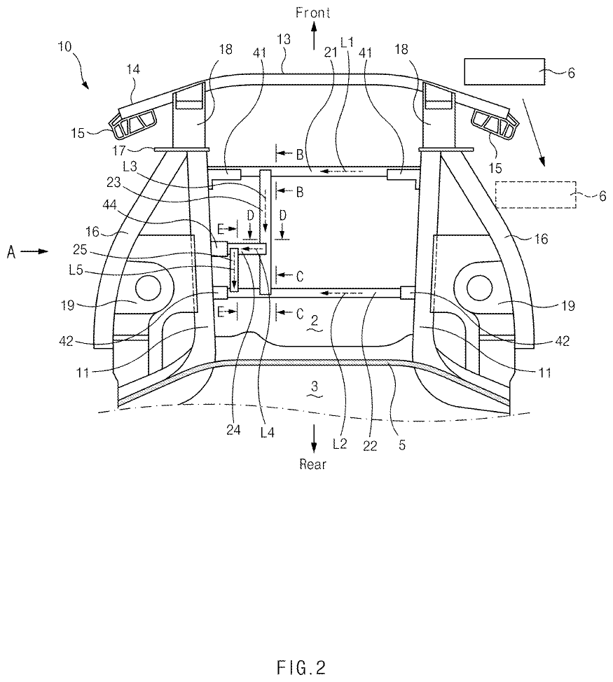

Referring to FIGS. 1 and 2, a vehicle front structure 10 according to an example embodiment of the present disclosure may include a pair of front side members 11, a first transverse member 21 connected between front portions of the pair of front side members 11, a second transverse member 22 connected between rear portions of the pair of front side members 11, and a plurality of front modules 51, 52, and 53 mounted on a top surface of the first transverse member 21 and a top surface of the second transverse member 22.

Each front side member 11 may extend from a dash panel 5 toward the front of the vehicle in a longitudinal direction of the vehicle, and the pair of front side members 11 may be spaced apart from each other in a width direction of the vehicle. The dash panel 5 may be designed to separate a front compartment 2 from a passenger compartment 3.

A front bumper beam 13 may be located on the front of the pair of front side members 11. A front end of each front side member 11 may be connected to the front bumper beam 13 through a crash box 18. A front end of the crash box 18 may be fixed to the front bumper beam 13, and a rear end of the crash box 18 may be connected to the front end of the corresponding front side member 11 through a mounting plate 17. The front end of the front side member 11 may be fixed to a rear surface of the mounting plate 17, and the rear end of the crash box 18 may be fixed to a front surface of the mounting plate 17.

The front bumper beam 13 may have a pair of bumper beam extension portions 14 extending from both ends thereof toward the exterior of the vehicle. A pair of deflectors 15 may be mounted on the pair of bumper beam extension portions 14, respectively.

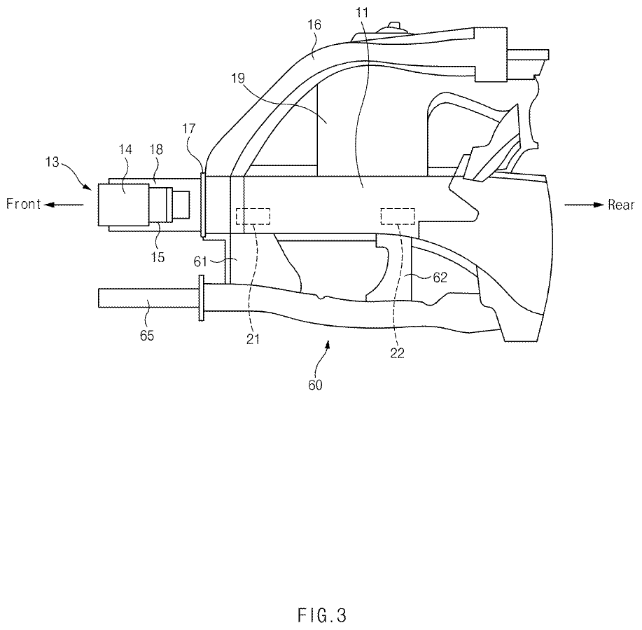

A pair of fender apron members 16 may be spaced apart from each other in the width direction of the vehicle. Referring to FIGS. 1 and 2, each fender apron member 16 may be spaced apart from the corresponding front side member 11 toward the exterior of the vehicle, and a front end of each fender apron member 16 together with the front end of the corresponding front side member 11 may be fixed to the mounting plate 17. Referring to FIG. 3, each fender apron member 16 may be located above the corresponding front side member 11, and be curved toward the front end of the corresponding front side member 11.

Referring to FIGS. 1 and 2, a pair of suspension towers 19 may be mounted on the pair of fender apron members 16, and an upper portion of a suspension damper such as a shock absorber may be mounted on each suspension tower 19. Each suspension tower 19 may be connected transverse to the fender apron member 16 and the adjacent front side member 11. A top end of each suspension tower 19 may be fixed to the fender apron member 16, and a bottom end of each suspension tower 19 may be fixed to the front side member 11.

The first transverse member 21 may connect the front portions of the pair of front side members 11 along the width direction of the vehicle. Referring to FIG. 2, the first transverse member 21 may extend along the width direction of the vehicle between the front portions of the pair of front side members 11, and the first transverse member 21 may define a transverse load path L1 extending along the width direction of the vehicle between the front portions of the pair of front side members 11.

Both end portions of the first transverse member 21 may be connected to the front portions of the pair of front side members 11, respectively, and each end portion of the first transverse member 21 may be adjacent to the corresponding mounting plate 17. Referring to FIG. 2, both end portions of the first transverse member 21 may be mounted on the front portions of the pair of front side members 11 through a pair of first mounting brackets 41, respectively. The pair of first mounting brackets 41 may be fixed to the pair of front side members 11, respectively, and the pair of first mounting brackets 41 may face each other. Each end portion of the first transverse member 21 may be fixed to the corresponding first mounting bracket 41 using fasteners, welding, and/or the like. According to an example embodiment, the first transverse member 21 may be a frunk bar.

The second transverse member 22 may connect the rear portions of the pair of front side members 11 along the width direction of the vehicle. The second transverse member 22 may be spaced apart from the first transverse member 21 toward the rear of the vehicle, and the second transverse member 22 may be parallel to the first transverse member 21. Referring to FIG. 2, the second transverse member 22 may extend along the width direction of the vehicle between the rear portions of the pair of front side members 11, and the second transverse member 22 may define a transverse load path L2 extending along the width direction of the vehicle between the rear portions of the pair of front side members 11.

Both end portions of the second transverse member 22 may be mounted on the rear portions of the pair of front side members 11, respectively, and the second transverse member 22 may be adjacent to the dash panel 5. Referring to FIG. 2, both end portions of the second transverse member 22 may be mounted on the rear portions of the pair of front side members 11 through a pair of second mounting brackets 42, respectively. The pair of second mounting brackets 42 may be fixed to the pair of front side members 11, respectively, and the pair of second mounting brackets 42 may face each other. Each end portion of the second transverse member 22 may be fixed to the corresponding second mounting bracket 42 using fasteners, welding, and/or the like.

The plurality of front modules 51, 52, and 53 may be various components located in the front compartment 2. According to an example embodiment, the plurality of front modules 51, 52, and 53 may be mounted on the top surface of the first transverse member 21 and the top surface of the second transverse member 22 using fasteners, welding, and/or the like so that the plurality of front modules 51, 52, and 53 may be stably supported by the first transverse member 21 and the second transverse member 22. In addition, at least a portion of the front modules 51, 52, and 53 may be mounted on the top surface of at least one front side member 11 of the pair of front side members 11. Accordingly, the plurality of front modules 51, 52, and 53 may be connected to a vehicle body through the first transverse member 21 and the second transverse member 22 between the pair of front side members 11 so that the plurality of front modules 51, 52, and 53 may serve as load paths between the pair of front side members 11.

The plurality of front modules 51, 52, and 53 may include a first front module 51, a second front module 52, and a third front module 53. The first front module 51 may have a relatively large size, and the second front module 52 and the third front module 53 may have relatively smaller sizes than the size of the first front module 51. For example, the first front module 51 may be a power electronics (PE) module which is a power source of an electric vehicle, the second front module 52 may be a cooling module, and the third front module 53 may be an auxiliary battery (a 12V-battery or the like) supplying power to various accessories.

The vehicle front structure 10 according to an example embodiment of the present disclosure may further include a longitudinal member 23 connecting the first transverse member 21 and the second transverse member 22 along the longitudinal direction of the vehicle.

Referring to FIG. 2, the longitudinal member 23 may extend along the longitudinal direction of the vehicle between the first transverse member 21 and the second transverse member 22, and the longitudinal member 23 may define a longitudinal load path L3 extending along the longitudinal direction of the vehicle between the first transverse member 21 and the second transverse member 22. A front end portion of the longitudinal member 23 may be fixed to the first transverse member 21, and a rear end portion of the longitudinal member 23 may be fixed to the second transverse member 22.

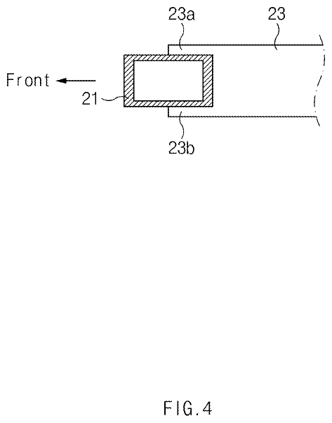

Referring to FIG. 4, the longitudinal member 23 may include a first upper extension portion 23a and a first lower extension portion 23b provided on the front end portion thereof. The first upper extension portion 23a and the first lower extension portion 23b may extend from a front end surface of the longitudinal member 23 toward the front of the vehicle, and the first upper extension portion 23a and the first lower extension portion 23b may be spaced apart from each other by a gap corresponding to a height of the first transverse member 21 so that the longitudinal member 23 may have a U-shaped recess formed in the front end portion thereof, and the first transverse member 21 may be fitted into the U-shaped recess. The first upper extension portion 23a may be horizontally flat to match the top surface of the first transverse member 21, and the first upper extension portion 23a may be fixed to the top surface of the first transverse member 21 using welding (CO₂ welding or the like), fasteners, and/or the like. The first lower extension portion 23b may be horizontally flat to match a bottom surface of the first transverse member 21, and the first lower extension portion 23b may be fixed to the bottom surface of the first transverse member 21 using welding (CO₂ welding or the like), fasteners, and/or the like. The front end surface of the longitudinal member 23 may be vertically flat to match a rear surface of the first transverse member 21, and the front end surface of the longitudinal member 23 may be fixed to the rear surface of the first transverse member 21 using welding (CO₂ welding or the like), fasteners, and/or the like. Accordingly, the front end portion of the longitudinal member 23 may be mechanically and firmly fixed to the first transverse member 21. The front end portion of the longitudinal member 23 may be very firmly fixed to the first transverse member 21 through a mechanical joint system.

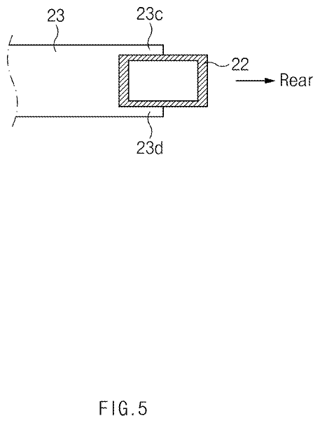

Referring to FIG. 5, the longitudinal member 23 may include a second upper extension portion 23c and a second lower extension portion 23d provided on the rear end portion thereof. The second upper extension portion 23c and the second lower extension portion 23d may extend from a rear end surface of the longitudinal member 23 toward the rear of the vehicle, and the second upper extension portion 23c and the second lower extension portion 23d may be spaced apart from each other by a gap corresponding to a height of the second transverse member 22 so that the longitudinal member 23 may have a U-shaped recess formed in the rear end portion thereof, and the second transverse member 22 may be fitted into the U-shaped recess. The second upper extension portion 23c may be horizontally flat to match the top surface of the second transverse member 22, and the second upper extension portion 23c may be fixed to the top surface of the second transverse member 22 using welding (CO₂ welding or the like), fasteners, and/or the like. The second lower extension portion 23d may be horizontally flat to match a bottom surface of the second transverse member 22, and the second lower extension portion 23d may be fixed to the bottom surface of the second transverse member 22 using welding (CO₂ welding or the like), fasteners, and/or the like. The rear end surface of the longitudinal member 23 may be vertically flat to match a front surface of the second transverse member 22, and the rear end surface of the longitudinal member 23 may be fixed to the front surface of the second transverse member 22 using welding (CO₂ welding or the like), fasteners, and/or the like. Accordingly, the rear end portion of the longitudinal member 23 may be mechanically and firmly fixed to the second transverse member 22. The rear end portion of the longitudinal member 23 may be very firmly fixed to the second transverse member 22 through a mechanical joint system.

Referring to FIG. 2, the vehicle front structure 10 according to an example embodiment of the present disclosure may further include a middle transverse member 24 connecting any one of the pair of front side members 11 and the longitudinal member 23 along the width direction of the vehicle. For example, the middle transverse member 24 may connect the left front side member 11 and the longitudinal member 23. The middle transverse member 24 may be located between the first transverse member 21 and the second transverse member 22, and the middle transverse member 24 may be parallel to the first transverse member 21 and the second transverse member 22. The middle transverse member 24 may extend along the width direction of the vehicle between the left front side member 11 and the longitudinal member 23, and the middle transverse member 24 may define a transverse load path L4 extending along the width direction of the vehicle between the left front side member 11 and the longitudinal member 23.

The middle transverse member 24 may include a first end portion connected to any one of the pair of front side members 11, and a second end portion connected to the longitudinal member 23. The first end portion of the middle transverse member 24 may be mounted on any one of the pair of front side members 11 through a mounting bracket 44. The mounting bracket 44 may be fixed to the left front side member 11 using fasteners, welding, and/or the like, and the first end portion of the middle transverse member 24 may be fixed to the mounting bracket 44 using fasteners, welding, and/or the like.

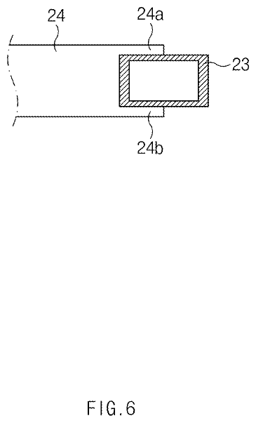

Referring to FIG. 6, the middle transverse member 24 may include an upper extension portion 24a and a lower extension portion 24b provided on the second end portion thereof. The upper extension portion 24a and the lower extension portion 24b may extend from a second end surface of the middle transverse member 24 along the width direction of the vehicle, and the upper extension portion 24a and the lower extension portion 24b may be spaced apart from each other by a gap corresponding to a height of the longitudinal member 23 so that the middle transverse member 24 may have a U-shaped recess formed in the second end portion thereof, and the longitudinal member 23 may be fitted into the U-shaped recess. The upper extension portion 24a may be horizontally flat to match a top surface of the longitudinal member 23, and the upper extension portion 24a may be fixed to the top surface of the longitudinal member 23 using welding (CO₂ welding or the like), fasteners, and/or the like. The lower extension portion 24b may be horizontally flat to match a bottom surface of the longitudinal member 23, and the lower extension portion 24b may be fixed to the bottom surface of the longitudinal member 23 using welding (CO₂ welding or the like), fasteners, and/or the like. The second end surface of the middle transverse member 24 may be vertically flat to match one side surface of the longitudinal member 23, and the second end surface of the middle transverse member 24 may be fixed to one side surface of the longitudinal member 23 using welding (CO₂ welding or the like), fasteners, and/or the like. Accordingly, the second end portion of the middle transverse member 24 may be mechanically and firmly fixed to the longitudinal member 23. The second end portion of the middle transverse member 24 may be very firmly fixed to the longitudinal member 23 through a mechanical joint system.

The vehicle front structure 10 according to an example embodiment of the present disclosure may further include an additional longitudinal member 25 connecting the middle transverse member 24 and the second transverse member 22 along the longitudinal direction of the vehicle.

Referring to FIG. 2, the additional longitudinal member 25 may extend along the longitudinal direction of the vehicle between the middle transverse member 24 and the second transverse member 22, and the additional longitudinal member 25 may define a longitudinal load path L5 extending along the longitudinal direction of the vehicle between the middle transverse member 24 and the second transverse member 22. A front end portion of the additional longitudinal member 25 may be fixed to the middle transverse member 24, and a second end portion of the additional longitudinal member 25 may be fixed to the second transverse member 22.

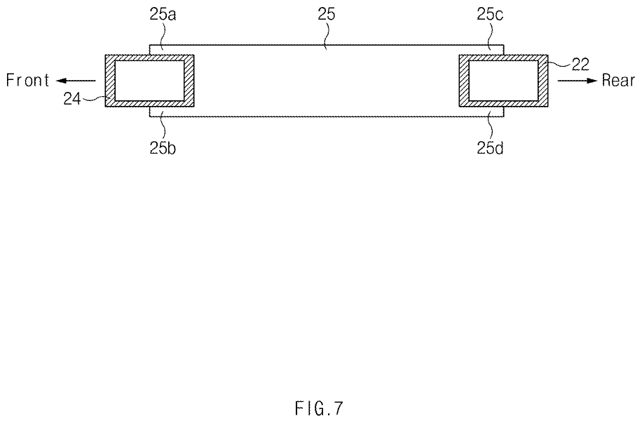

Referring to FIG. 7, the additional longitudinal member 25 may include a first upper extension portion 25a and a first lower extension portion 25b provided on the front end portion thereof. The first upper extension portion 25a and the first lower extension portion 25b may extend from a front end surface of the additional longitudinal member 25 toward the front of the vehicle, and the first upper extension portion 25a and the first lower extension portion 25b may be spaced apart from each other by a gap corresponding to a height of the middle transverse member 24 so that the additional longitudinal member 25 may have a U-shaped recess formed in the front end portion thereof, and the middle transverse member 24 may be fitted into the U-shaped recess. The first upper extension portion 25a may be horizontally flat to match a top surface of the middle transverse member 24, and the first upper extension portion 25a may be fixed to the top surface of the middle transverse member 24 using welding (CO₂ welding or the like), fasteners, and/or the like. The first lower extension portion 25b may be horizontally flat to match a bottom surface of the middle transverse member 24, and the first lower extension portion 25b may be fixed to the bottom surface of the middle transverse member 24 using welding (CO₂ welding or the like), fasteners, and/or the like. The front end surface of the additional longitudinal member 25 may be vertically flat to match a rear surface of the middle transverse member 24, and the front end surface of the additional longitudinal member 25 may be fixed to the rear surface of the middle transverse member 24 using welding (CO₂ welding or the like), fasteners, and/or the like. Accordingly, the front end portion of the additional longitudinal member 25 may be mechanically and firmly fixed to the middle transverse member 24. The front end portion of the additional longitudinal member 25 may be very firmly fixed to the middle transverse member 24 through a mechanical joint system.

Referring to FIG. 7, the additional longitudinal member 25 may include a second upper extension portion 25c and a second lower extension portion 25d provided on the rear end portion thereof. The second upper extension portion 25c and the second lower extension portion 25d may extend from a rear end surface of the additional longitudinal member 25 toward the rear of the vehicle, and the second upper extension portion 25c and the second lower extension portion 25d may be spaced apart from each other by a gap corresponding to a height of the second transverse member 22 so that the additional longitudinal member 25 may have a U-shaped recess formed in the rear end portion thereof, and the second transverse member 22 may be fitted into the U-shaped recess. The second upper extension portion 25c may be horizontally flat to match the top surface of the second transverse member 22, and the second upper extension portion 25c may be fixed to the top surface of the second transverse member 22 using welding (CO₂ welding or the like), fasteners, and/or the like. The second lower extension portion 25d may be horizontally flat to match the bottom surface of the second transverse member 22, and the second lower extension portion 25d may be fixed to the bottom surface of the second transverse member 22 using welding (CO₂ welding or the like), fasteners, and/or the like. The rear end surface of the additional longitudinal member 25 may be vertically flat to match the front surface of the second transverse member 22, and the rear end surface of the additional longitudinal member 25 may be fixed to the front surface of the second transverse member 22 using welding (CO₂ welding or the like), fasteners, and/or the like. Accordingly, the rear end portion of the additional longitudinal member 25 may be mechanically and firmly fixed to the second transverse member 22. The rear end portion of the additional longitudinal member 25 may be very firmly fixed to the second transverse member 22 through a mechanical joint system.

Referring to FIG. 1, the plurality of front modules 51, 52, and 53 may be mounted on the top surface of the first transverse member 21, the top surface of the second transverse member 22, the top surface of the longitudinal member 23, the top surface of the middle transverse member 24, and a top surface of the additional longitudinal member 25 using fasteners, welding, and/or the like so that the plurality of front modules 51, 52, and 53 may be stably supported by the first transverse member 21, the second transverse member 22, the longitudinal member 23, the middle transverse member 24, and the additional longitudinal member 25. Accordingly, the plurality of front modules 51, 52, and 53 may be connected to the vehicle body through the first transverse member 21, the second transverse member 22, the longitudinal member 23, the middle transverse member 24, and the additional longitudinal member 25 between the pair of front side members 11 so that the plurality of front modules 51, 52, and 53 may serve as the load paths between the pair of front side members 11.

A front edge of the first front module 51 may be fixed to the top surface of the first transverse member 21 using fasteners, welding, and/or the like, and a rear edge of the first front module 51 may be fixed to the top surface of the second transverse member 22 using fasteners, welding, and/or the like.

A front edge of the second front module 52 may be fixed to the top surface of the first transverse member 21 using fasteners, welding, and/or the like, and a rear edge of the second front module 52 may be fixed to the top surface of the middle transverse member 24 using fasteners, welding, and/or the like.

A front edge of the third front module 53 may be fixed to the top surface of the middle transverse member 24 using fasteners, welding, and/or the like, and a rear edge of the third front module 53 may be fixed to the top surface of the second transverse member 22 using fasteners, welding, and/or the like. In addition, a bottom surface of the third front module 53 may be fixed to the top surface of the additional longitudinal member 25 using fasteners, welding, and/or the like so that the bottom surface of the third front module 53 may be firmly supported by the additional longitudinal member 25.

Referring to FIG. 2, when a barrier 6 collides with the right bumper beam extension portion 14 of the front bumper beam 13 in a small overlap crash, the deflector 15 of the right bumper beam extension portion 14 may impact the right front side member 11, and an impact load may be primarily transferred along the transverse load path L1 defined by the first transverse member 21. After a selected, set, or predetermined period of time has elapsed, the impact load may be secondarily transferred along the transverse load path L2 defined by the second transverse member 22. The impact load may be primarily transferred by the first transverse member 21 between the front portions of the pair of front side members 11 and then be secondarily transferred by the second transverse member 22 between the rear portions of the pair of front side members 11, and accordingly the load transfer through the second transverse member 22 may be relatively delayed compared to the load transfer through the first transverse member 21. In addition, the impact load may be transferred along the longitudinal load path L3 defined by the longitudinal member 23 between the first transverse member 21 and the second transverse member 22 in the longitudinal direction of the vehicle, be transferred along the transverse load path L4 defined by the middle transverse member 24 between the longitudinal member 23 and the front side member 11 in the width direction of the vehicle, and be transferred along the longitudinal load path L5 defined by the additional longitudinal member 25 between the middle transverse member 24 and the second transverse member 22 in the longitudinal direction of the vehicle so that a time interval between the load transfer through the first transverse member 21 and the load transfer through the second transverse member 22 may be reduced. Because the impact load can be quickly transferred in the width direction of the vehicle, a lateral displacement of the vehicle may be made efficiently and quickly. As the lateral displacement of the vehicle is made efficiently and quickly in the event of a small overlap crash, the amount of overlap between the barrier 6 and the vehicle may be significantly reduced.

Referring to FIG. 3, the vehicle front structure 10 according to an example embodiment of the present disclosure may include a front subframe 60 located below the pair of front side members 11. The front subframe 60 may include a pair of lower stiffeners 65, a pair of front mounts 61 mounted on the front portions of the pair of front side members 11, and a pair of rear mounts 62 mounted on the rear portions of the pair of front side members 11.

Each lower stiffener 65 may extend from a front end of the front subframe 60 toward the front of the vehicle.

Each front mount 61 may protrude from a front portion of the front subframe 60 toward the corresponding front side member 11, and the front mount 61 may be mounted on the front portion of the corresponding front side member 11 by mounting hardware. The first transverse member 21 may be aligned with the front mount 61 in a vertical direction.

Each rear mount 62 may protrude from a rear portion of the front subframe 60 toward the corresponding front side member 11, and the rear mount 62 may be mounted on the rear portion of the corresponding front side member 11 by mounting hardware. The second transverse member 22 may be aligned with the rear mount 62 in a vertical direction.

In the event of a frontal impact/collision or a small overlap crash, the impact load may be transferred to the front subframe 60 through the lower stiffener 65. As the first transverse member 21 is vertically aligned with the front mount 61, the impact load transferred to the front subframe 60 may be quickly transferred to the first transverse member 21 through the front mount 61, and as the second transverse member 22 is vertically aligned with the rear mount 62, the impact load transferred to the front subframe 60 may be quickly transferred to the second transverse member 22 through the rear mount 62. Accordingly, the impact load may be quickly transferred to the first transverse member 21 and the second transverse member 22 through the front subframe 60 so that the lateral displacement of the vehicle may be made quickly and efficiently.

As set forth above, the vehicle front structure according to example embodiments of the present disclosure may be designed to use the plurality of transverse members provided on the front of the vehicle body and the plurality of front modules mounted on the plurality of transverse members as the load paths, thereby effectively causing the lateral displacement of the vehicle in the event of small overlap crashes.

Hereinabove, although the present disclosure has been described with reference to example embodiments and the accompanying drawings, the present disclosure is not necessarily limited thereto, but may be variously modified and altered by those skilled in the art to which the present disclosure pertains without departing from the spirit and scope of the present disclosure claimed in the following claims.

What is claimed is:

1. A vehicle front structure, comprising:
a pair of front side members;
a first transverse member connecting front portions of the pair of front side members in a width direction of a vehicle;
a second transverse member connecting rear portions of the pair of front side members in the width direction of the vehicle; and
a plurality of front modules mounted on the first transverse member and the second transverse member.

2. The structure of claim 1, wherein both end portions of the first transverse member are mounted on the front portions of the pair of front side members through a pair of first mounting brackets, respectively.

3. The structure of claim 1, wherein both end portions of the second transverse member are mounted on the rear portions of the pair of front side members through a pair of second mounting brackets, respectively.

4. The structure of claim 1, further comprising a longitudinal member connecting the first transverse member and the second transverse member in a longitudinal direction of the vehicle.

5. The structure of claim 4, wherein a front end portion of the longitudinal member includes a first upper extension portion fixed to a top surface of the first transverse member, and a first lower extension portion fixed to a bottom surface of the first transverse member.

6. The structure of claim 4, wherein a rear end portion of the longitudinal member includes a second upper extension portion fixed to a top surface of the second transverse member, and a second lower extension portion fixed to a bottom surface of the second transverse member.

7. The structure of claim 4, further comprising a middle transverse member connecting any one of the pair of front side members and the longitudinal member in the width direction of the vehicle.

8. The structure of claim 7, wherein the middle transverse member includes a first end portion connected to any one of the pair of front side members, and a second end portion connected to the longitudinal member.

9. The structure of claim 8, wherein the first end portion of the middle transverse member is mounted on any one of the pair of front side members through a mounting bracket.

10. The structure of claim 8, wherein the second end portion of the middle transverse member includes an upper extension portion fixed to a top surface of the longitudinal member, and a lower extension portion fixed to a bottom surface of the longitudinal member.

11. The structure of claim 7, further comprising an additional longitudinal member connecting the middle transverse member and the second transverse member in the longitudinal direction of the vehicle.

12. The structure of claim 11, wherein a front end portion of the additional longitudinal member includes a first upper extension portion fixed to a top surface of the middle transverse member, and a first lower extension portion fixed to a bottom surface of the middle transverse member.

13. The structure of claim 11, wherein a rear end portion of the additional longitudinal member includes a second upper extension portion fixed to a top surface of the second transverse member, and a second lower extension portion fixed to a bottom surface of the second transverse member.

14. The structure of claim 1, further comprising a front subframe located below the pair of front side members,
wherein the front subframe includes a front mount mounted on the front portion of each front side member, and a rear mount mounted on the rear portion of each front side member.

15. The structure of claim 14, wherein the first transverse member is vertically aligned with the front mount, and
the second transverse member is vertically aligned with the rear mount.

16. A vehicle front structure, comprising:
a pair of front side members;
a first transverse member connecting front portions of the pair of front side members in a width direction of a vehicle, wherein both end portions of the first transverse member are mounted on the front portions of the pair of front side members through a pair of first mounting brackets, respectively;
a second transverse member connecting rear portions of the pair of front side members in the width direction of the vehicle, wherein both end portions of the second transverse member are mounted on the rear portions of the pair of front side members through a pair of second mounting brackets, respectively;
a plurality of front modules mounted on the first transverse member and the second transverse member;
a longitudinal member connecting the first transverse member and the second transverse member in a longitudinal direction of the vehicle, wherein a front end portion of the longitudinal member includes a first upper extension portion fixed to a top surface of the first transverse member, and a first lower extension portion fixed to a bottom surface of the first transverse member, and wherein a rear end portion of the longitudinal member includes a second upper extension portion fixed to a top surface of the second transverse member, and a second lower extension portion fixed to a bottom surface of the second transverse member; and
a front subframe located below the pair of front side members, wherein the front subframe includes a front mount mounted on the front portion of each front side member, and a rear mount mounted on the rear portion of each front side member, wherein the first transverse member is vertically aligned with the front mount, and wherein the second transverse member is vertically aligned with the rear mount.

17. A vehicle front structure, comprising:
a pair of front side members;
a first transverse member connecting front portions of the pair of front side members in a width direction of a vehicle;
a second transverse member connecting rear portions of the pair of front side members in the width direction of the vehicle;
a plurality of front modules mounted on the first transverse member and the second transverse member;
a pair of fender apron members adjacent the pair of front side members, respectively, wherein a rear end of each fender apron member is spaced apart from the corresponding front side member toward an exterior of the vehicle and extends above the corresponding front side member, and wherein a front end of each fender apron member is curved downward toward the front end of the corresponding front side member and is joined together proximate with the front end of the corresponding front side member; and
a front subframe located below the pair of front side members, wherein the front subframe includes a front mount mounted on the front portion of each front side member, and a rear mount mounted on the rear portion of each front side member, wherein the first transverse member is vertically aligned with the front mount, and wherein the second transverse member is vertically aligned with the rear mount.

18. The structure of claim 17, further comprising:
a longitudinal member connecting the first transverse member and the second transverse member in a longitudinal direction of the vehicle, wherein a first front end portion of the longitudinal member includes a first upper extension portion fixed to a first top surface of the first transverse member, and a first lower extension portion fixed to a first bottom surface of the first transverse member, and wherein a first rear end portion of the longitudinal member includes a second upper extension portion fixed to a second top surface of the second transverse member, and a second lower extension portion fixed to a second bottom surface of the second transverse member;
a middle transverse member connecting any one of the pair of front side members and the longitudinal member in the width direction of the vehicle, wherein the middle transverse member includes a first end portion connected to any one of the pair of front side members, and a second end portion connected to the longitudinal member, wherein the second end portion of the middle transverse member includes a middle upper extension portion fixed to a third top surface of the longitudinal member, and wherein a middle lower extension portion fixed to a third bottom surface of the longitudinal member; and
an additional longitudinal member connecting the middle transverse member and the second transverse member in the longitudinal direction of the vehicle, wherein a second front end portion of the additional longitudinal member includes a first additional upper extension portion fixed to a fourth top surface of the middle transverse member, and a first additional lower extension portion fixed to a fourth bottom surface of the middle transverse member, and wherein a second rear end portion of the additional longitudinal member includes a second additional upper extension portion fixed to a fifth top surface of the second transverse member, and a second additional lower extension portion fixed to a fifth bottom surface of the second transverse member.

19. The structure of claim 18, wherein both end portions of the first transverse member are mounted on the front portions of the pair of front side members through a pair of first mounting brackets, respectively,
wherein both end portions of the second transverse member are mounted on the rear portions of the pair of front side members through a pair of second mounting brackets, respectively, and
wherein the first end portion of the middle transverse member is mounted on any one of the pair of front side members through a third mounting bracket.
